(19) United States
(12) Patent Application Publication
(10) Pub. No.: US 2010/0237976 A1
(43) Pub. Date: Sep. 23, 2010

(54) LOW-PROFILE INDUCTIVE COIL AND METHOND OF MANUFACTURE

(76) Inventors: Chiu K. Li, San Diego, CA (US); David K.J. Kim, San Diego, CA (US)

Correspondence Address: KYOCERA INTERNATIONAL INC.;INTELLECTUAL PROPERY DEPARTMENT, P.O. BOX 928289, SAN DIEGO, CA, 92192, US

(21) Appl. No.: 12/405,630

(22) Filed: Mar. 17, 2009

(51) Int. Cl. H01F 5/00; H04R 25/00; H01F 41/00

(52) U.S. Cl. 336/200; 381/331; 29/602.1

(57) ABSTRACT

Disclosed is an inductive coil comprising a non-conductive substrate, a plurality of insulator layers laminated in a stack over the non-conductive substrate, and a plurality of conductive layers interleaved between the insulator layers. A hole passes through the conductive and insulator layers, and a magnetic core is placed in the hole and over the substrate. Each of the conductive layers includes a single-layer conductive trace coiled around the hole with an isolating gap between each turn of the conductive trace. At least one plated via passes through at least one of the insulator layers to connect traces of at least two conductive layers. The inductive coil may be a Hearing Aid Compliant (HAC) T-coil, includable in a wireless communication device, such as a cellular phone. A method of manufacturing the inductive coil is also disclosed.

### TECHNICAL FIELD

The present invention generally relates to inductive devices, and more particularly, to inductive coils used in electronic devices.

### BACKGROUND

An inductive coil is a device that generates a magnetic field in response to changes in electrical current passing through the coil. Generally, the coil includes a number of wire turns around a core. As current flows through the wire, a magnetic field is produced predominately in the core.

Inductive coils are presently being included in many telephones, both wireless and landline, in order to make the telephones compatible with hearing aids. These inductive coils are referred to as Hearing Aid Compatible (HAC) coils. The HAC coil acts as an antenna, and broadcasts an audio signal received by the telephone through a magnetic field to a nearby hearing aid, which contains a TeleCoil (T-coil) that acts as a receiving antenna.

A T-coil is a small inductive coil that is built into some hearing aids for use with telephones, as well as some assistive listening devices. To use the T-coil, generally either the hearing aid is switched to a “T” position or a button on the hearing aid is pushed to select a T-coil program. The T-coil picks up magnetic fields generated by HAC coils in HAC telephones, and then the hearing aid converts these fields into sound. T-coils are particularly useful for telephone communication because they permit the volume control of a hearing aid to be turned up without creating feedback or “whistling,” and also background noise can be reduced, especially when using cell phones in noisy places.

The Federal Communications Commission (FCC) has mandated that all major wireless handset manufacturers are now required to produce cellular phones that are HAC, and thus, include HAC coils. In order for a telephone to be HAC, the telephone must deliver enough magnetic field proximate the ear speaker so that the hearing-aid device, which is in T-coil mode, can pick-up the magnetic field delivered by the phone. The FCC relies on standards, such as American Natural Standards Institute (ANSI) C63.19-2001, 68 FCC part 68 (47 C.F.R. 68) and International Telecommunication Union-Telecommunication (ITU-T) standards to define the requirements for hearing-aid compatibility. For example, in order for a mobile telephone to be considered compliant under the FCC ruling, it must meet ANSI C63.19-2001 Category U3 radio frequency performance standards.

For a HAC coil to be added to a mobile phone, it should meet current trends in mobile phone manufacturing, in particular, the decreasing size of the mobile phone and decreasing unit cost. Thus, in order for the HAC components to be viable, the HAC inductive coil must minimize the amount of space it will occupy within the mobile telephone housing (i.e., handset, headset or other such housing) and it must be an economically feasible solution that will not impart any unnecessary additional costs to the unit price of the mobile telephone.

Thus, there is a need for an improved inductive coil that can meet the HAC requirements and design constraints of contemporary mobile wireless devices.

### SUMMARY

Disclosed is an inductive coil comprising a non-conductive substrate, a plurality of insulator layers laminated in a stack over the non-conductive substrate, and a plurality of conductive layers interleaved between the insulator layers. A hole passes through the conductive and insulator layers, and a magnetic core is placed in the hole, above the substrate. Each of the conductive layers includes a single-layer conductive trace coiled around the hole with an isolating gap between each turn of the conductive trace. At least one plated via passes through at least one of the insulator layers to connect traces of at least two conductive layers. The inductive coil may be a Hearing Aid Compliant (HAC) inductive coil, includable in a wireless communication device, such as a cellular phone. A method of manufacturing the inductive coil is also disclosed.

Other aspects, features, advantages of the disclosed inductive coil and its method of manufacture will be or will become apparent to one with skill in the art upon examination of the following figures and detailed description. It is intended that all such additional aspects, features, and advantages be included within this description and be protected by the accompanying claims.

### BRIEF DESCRIPTION OF THE DRAWINGS

It is to be understood that the drawings are solely for purpose of illustration and do not define the limits of the invention. Furthermore, the components in the figures are not necessarily to scale. In the figures, like reference numerals designate corresponding parts throughout the different views.

FIG. 1 is a schematic diagram of a wireless communication device magnetically coupled to a hearing aid T-coil.

FIG. 2 is a cross-sectional view of an exemplary low-profile HAC coil.

FIG. 3 is a partially-exploded perspective view of the HAC coil shown in FIG. 2.

FIG. 4 is a top plan view of the HAC coil shown in FIG. 2, with the cover layer removed.

### DETAILED DESCRIPTION

The following detailed description, which references to and incorporates the drawings, describes and illustrates one or more specific embodiments of the invention. These embodiments, offered not to limit but only to exemplify and teach the invention, are shown and described in sufficient detail to enable those skilled in the art to practice the invention. Thus, where appropriate to avoid obscuring the invention, the description may omit certain information known to those of skill in the art.

The word “exemplary” is used throughout this disclosure to mean “serving as an example, instance, or illustration.” Any embodiment or feature described herein as “exemplary” is not necessarily to be construed as preferred or advantageous over other embodiments or features.

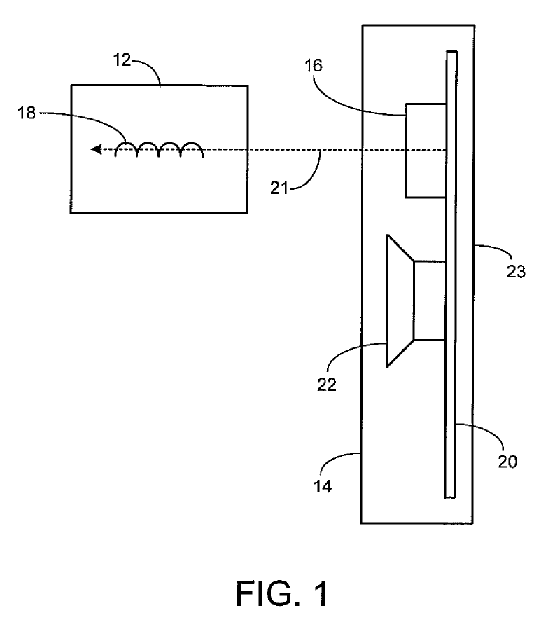

FIG. 1 is a schematic diagram of an exemplary system 10 including a wireless communication device (WCD) 14 and a hearing aid 12. The WCD 14 can be magnetically coupled to a T-coil 18 included in the hearing aid 12. Such coil-equipped WCDs are often termed type-HAC, or Hearing Aid Compatible (HAC) handsets because they meet the HAC requirements promulgated by the FCC. A low-profile HAC coil 16 in the WCD 14 produces a magnetic field 21, which couples with the counter-part T-coil 18 within the nearby hearing aid 12, when the latter is held near the WCD 14.

The T-coil coupling can magnetically transfer an electronic audio signal received by an audio transducer 22, such as a speaker, in the WCD 14 to the hearing aid 12, thus allowing the hearing aid 12 to receive an electronic signal equivalent to that received by the speaker 22. The hearing aid 12 then delivers the signal to an earpiece, or other device, for output to a hearing-impaired person. The hearing aid 12 may apply signal-processing techniques to the audio signal, to render the signal more intelligible to the hearing-impaired person.

The HAC coil 16 and speaker 22 may be mounted on a common substrate 20, such as a printed circuit board (PCB), within the housing 23 of the WCD 14.

The WCD 14 may be any wireless communication device, such as a cellular phone, headset, personal digital assistant (PDA), smart phone, or the like. In addition, the HAC coil 16 may be used in other devices, such as landline phones, wired headsets, assisted-living devices or the like.

The HAC coil 16 is typically physically positioned proximate the audio transducer 22 of the WCD 14. Positioning the HAC coil 16 proximate the audio transducer 22 can augment the magnetic field normally produced by the audio transducer 22, which may insure that the magnetic field from the HAC coil 16 coupled together with the magnetic field from the audio transducer 22 provides requisite magnetic field emissions for meeting the HAC specifications. In certain configurations, the audio transducer 22 may not emit any magnetic field, such as in the case of a piezoelectric transducer. In such configurations, the HAC coil 16 described herein does not need to be located near the audio transducer 22, but is still typically located within the WCD 14 at a position which can be conveniently placed proximate the user's hearing aid T-coil 18.

Alternatively, the HAC coil 16 may be remote from the audio transducer 22. For example the HAC coil 16 described herein may be included within a headset, helmet, hat, other headgear or other object that can be located proximate to a user's T-coil equipped hearing aid or other device, with electrical communication provided between the HAC coil 16 and a remote audio device, such as a WCD. In such circumstances, these objects may or may not be equipped with an audio transducer and, as such, may be specifically designed to impart magnetic field emissions to a user or user's hearing aid.

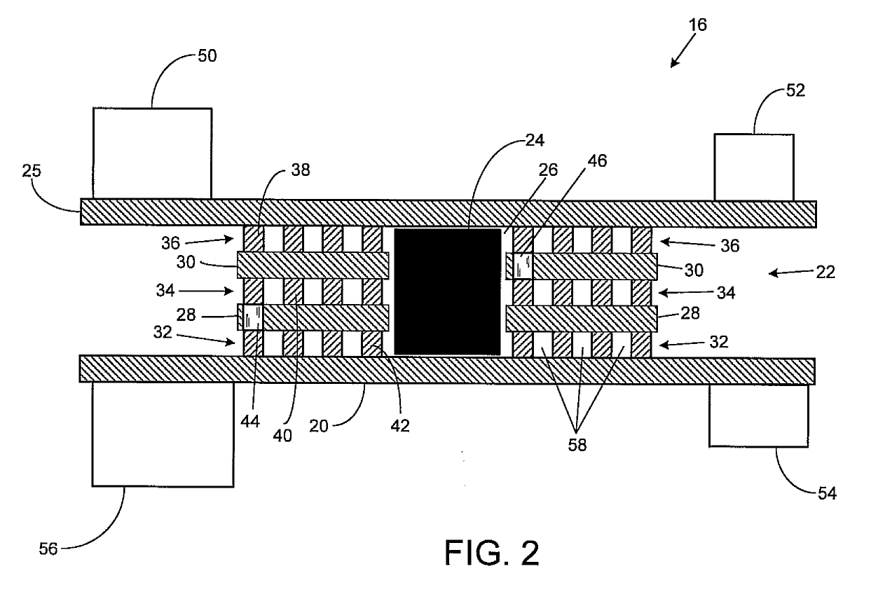

FIG. 2 is a cross-sectional view of the low-profile HAC coil 16 included in the WCD 14. The HAC coil 16 is an inductive coil assembly that includes a non-conductive substrate, such as a portion of PCB 20, a plurality of insulator layers 28, 30 laminated in a stack over the non-conductive substrate, and a plurality of conductive layers 32, 34, 36 interleaved between the insulator layers 28, 30. A hole 26 is formed in the conductive and insulator layers 28-36. A magnetic core 24 is placed in the hole 26, above the non-conductive substrate.

Each of the conductive layers 32, 34, 36 includes a single-layer conductive trace 38, 40, 42, respectively, coiled around the hole 26 with an isolating gap 58 between each turn of the conductive trace. A first plated via 44 passes through the lower insulator layer 28 to connect traces 40, 42 on the first and second conductive layers 32, 34. A second plated via 46 passes through the upper insulator layer 30 to connect traces 38, 40 on the second and third conductive layers 34, 36. Some of the vias may be buried vias within layers of a circuit board.

Each of the conductive traces 38, 30, 42 can be a suitable metal foil, such as copper, aluminum, gold or the like.

The insulator layers 28, 30 may be made of a non-conductive adhesive, such as a polyimide film, for adhering the conductive layers 32-36 into the stack. Alternatively, the insulator layers may be flexible printed circuit boards.

The HAC coil 16 is typically formed in a multi-turn arrangement and, additionally, is typically arranged in multiple layers. The numbers of layers and turns may be any suitable values, respectively. Multiple turns and multiple layers insure maximum magnetic field emission from the coil assembly.

A cover layer 25 can be attached over the insulator and conductive layers 28-36 to cover the hole 26 and hold the magnetic core 24 in place. The cover layer 25 may be a non-conductive substrate, such as a PCB or a flexible PCB.

One or more additional electronic components 50, 52 may be mounted onto the cover layer 25.

The non-conductive substrate 20 may be a flexible substrate, such as a flexible printed circuit board (FPC or FPCB). An FPCB is relatively thin when compared to conventional PCBs, and thus, has the advantage of reducing the overall height of the HAC coil 16. The FPCB is a printed circuit board having a substrate material composed of polyester resin or polyimide resin. The FPCB can be variously bent and folded according to the needs of any particular application. The substrate portion of a flexible printed circuit board is typically a film, which is used to support circuits typically composed of copper pieces. The flexible printed circuit board has properties of lightness, softness, thinness, smallness, ductility, flexibility and high wiring density. Accordingly, the flexible printed circuit board saves space, thereby downsizing the HAC coil 16. The flexible printed circuit board is therefore typically applied in small products, such as mobile phones, PDAs and the like.

In circumstances in which the HAC coil 16 is disposed on a flexible substrate it may be disposed on either planar side or both planar sides of the substrate. Alternatively, the HAC coil layers may be disposed on or within a printed circuit board or the coil layers may be a freestanding, substrate-free device.

One or more additional electronic components 54, 56 may be mounted onto the substrate 20.

The magnetic core 24 is made of any suitable material having a high magnetic permeability, such as a ferrite core. Magnetic flux density is much higher for the magnetic core material, and thus, results in a much greater magnetic field than a coil having an air core. Different shapes and materials made be used for the magnetic core 24.

Within the WCD 14, the magnetic field emitted by the HAC coil 16 is typically combined with the magnetic field of the audio transducer 22 to provide an overall increase in the magnetic field emitted by the WCD 14. The design, shape and number of layers of the HAC coil 16 may take various forms, so as to provide options in terms of the placement position within the WCD housing 23. The design of the HAC coil 16 may take into account the space constraints within the WCD housing 23 and the need to limit manufacturing costs associated with the WCD 14. The increase in magnetic field emission provided by the HAC coil 16 may permit WCDs, such as mobile telephones, to comply with the FCC HAC requirements.

The planar shape of the HAC coil assembly and the number of turns and/or layers in the coil assembly may be dictated by the magnitude of the magnetic field emission desired and the space limitations of the device.

The HAC coil 16 may be printed on the circuit board in multi-layer format using a photolithography process or other suitable PCB processing techniques. Alternatively, the HAC coil layers may be bonded or otherwise affixed to the circuit board after it has been fabricated. Alternatively, the HAC coil 16 may be embedded within the layers of the printed circuit board.

A technique for manufacturing the HAC coil 16 involves first providing a non-conductive substrate, such as an FPCB. A conductive layer, having a central hole, is then formed on the non-conductive substrate. The conductive layer may include a single-layer conductive trace coiled around the hole with an isolating gap between each turn of the conductive trace. Next, an insulator layer, having the same hole, is formed over the conductive layer. A plated via is formed passing through the insulator layer and connecting the trace on the conductive layer. The above steps of forming a conductive layer, insulator layer and plated via are repeated a number of times to form a laminated stack of interleaved conductive and insulator layers over the substrate. After the coil stack is formed, a magnetic core is placed into the cavity formed by the hole. The non-conductive substrate supports the bottom of the magnetic core. The layered stack can then be covered with a cover layer to enclose the magnetic core in the hole.

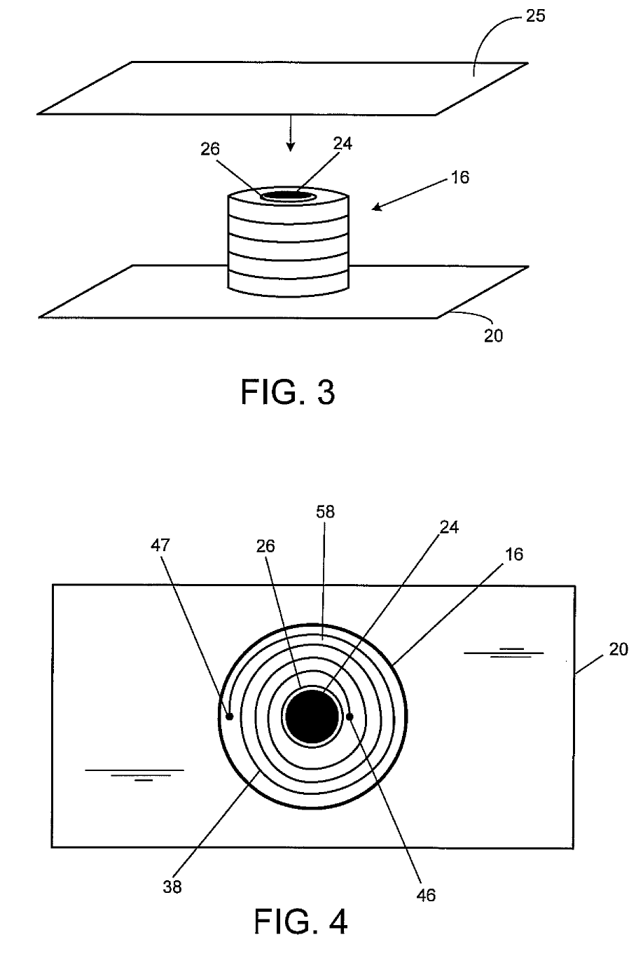

FIG. 3 is a partially-exploded perspective view of the exemplary HAC coil 16 shown in FIG. 2. Although shown as being cylindrically shaped, the HAC coil 16 may be constructed having any suitable shape, size or number of layers.

FIG. 4 is a top plan view of the HAC coil 16 shown in FIG. 2, with the cover layer 25 removed. This view illustrates the coiled turns of the conductive trace 38 of the upper-most conductive layer 36. The isolating gap 58 prevents the turns from shorting out with one another. Electrical contact 47 permits the trace 38 to be connected to a trace on the cover layer 25 for receiving current.

Although disclosed in the context of a HAC coil 16, the inductive coil assembly described herein may be used in devices other than a WCD and for purposes other than HAC.

Other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined with reference to the appended claims along with their full scope of equivalents.

What is claimed is:

1. An inductive coil, comprising:
a non-conductive substrate;
a plurality of insulator layers laminated in a stack over the non-conductive substrate, the insulator layers having a hole formed therein;
a plurality of conductive layers interleaved between the insulator layers and having the hole formed therein, each of the conductive layers including a single-layer conductive trace coiled around the hole with an isolating gap between each turn of the conductive trace;
at least one plated via passing through at least one of the insulator layers and connecting traces on at least two conductive layers; and
a magnetic core placed in the hole, above the non-conductive substrate.

2. The inductive coil of claim 1, further comprising:
a cover layer attached over the insulator and conductive layers to cover the hole and the magnetic core.

3. The inductive coil of claim 2, wherein additional electronic components are mounted on the cover layer.

4. The inductive coil of claim 1, wherein the conductive trace is a metal foil.

5. The inductive coil of claim 1, wherein the substrate is a flexible printed circuit board.

6. The inductive coil of claim 1, wherein the insulator layers are an adhesive.

7. The inductive coil of claim 6, wherein the insulator layers are a polyimide film.

8. The inductive coil of claim 1, wherein the magnetic core is a ferrite core.

9. The inductive coil of claim 1, wherein the insulator layers are flexible printed circuit boards.

10. The inductive coil of claim 1, wherein the inductive coil is a Hearing Aid Compliant (HAC) T-coil.

11. The inductive coil of claim 1, included in a wireless communication device.

12. The inductive coil of claim 11, wherein the wireless communication device is a Hearing Aid Compliant (HAC) device.

13. The inductive coil of claim 1, wherein additional electronic components are mounted on the non-conductive substrate.

14. A method of manufacturing an inductive coil, comprising:
(a) providing a non-conductive substrate;
(b) forming a conductive layer, having a hole, over the non-conductive substrate, the conductive layer including a single-layer conductive trace coiled around the hole with an isolating gap between each turn of the conductive trace;
(c) forming an insulator layer, having the hole, over the conductive layer;
(d) forming at least one plated via passing through the insulator layer and connecting the trace on the conductive layer;
(e) repeating (b) through (d) a predetermined number of times to form a laminated stack of interleaved conductive and insulator layers over the substrate; and
placing a magnetic core in the hole, above the non-conductive substrate.

15. The method of claim 14, further comprising:
attaching a cover layer over the laminated stack of interleaved insulator and conductive layers to cover the hole and the magnetic core.

16. The method of claim 15, further comprising:
mounting additional electronic components on the cover layer.

17. The method of claim 14, further comprising:
mounting additional electronic components on the substrate.

18. The method of claim 14, wherein the conductive trace is a metal foil.

19. The method of claim 14, wherein the substrate is a flexible printed circuit board.

20. The method of claim 14, wherein the inductive coil is a Hearing Aid Compliant (HAC) T-coil.
